(19) United States
(12) Patent Application Publication
(10) Pub. No.: US 2023/0181291 A1
(43) Pub. Date: Jun. 15, 2023

(54) STRUCTURE OF SELF-LIGATING BRACKET

(71) Applicant: ZE FANG LTD., New Taipei City (TW)

(72) Inventors: Yi-Wen Chen, New Taipei City (TW); Chih-Chang Tsai, New Taipei City (TW)

(21) Appl. No.: 17/551,183

(22) Filed: Dec. 15, 2021

(51) Int. Cl. A61C 7/28; A61C 7/30

(52) U.S. Cl. CPC A61C 7/287; A61C 7/30

(57) ABSTRACT

A self-ligating bracket includes a base body, a receiving channel formed in the base body, an elastic body including two elastic clamping arms, a connection part, and a receiving space, a movable lid movably arranged on the base body, a positioner arranged on a bottom of the movable lid and movable in the receiving channel, a sliding opening formed in a wall of the receiving channel, a retaining part formed on an end of the positioner, two avoiding spaces respectively formed between the elastic clamping arms and sidewalls of the receiving channel, and two guide slopes formed on two opposite sides of the positioner. The elastic clamping arms are provided to take the place of a spring or rubber ring in order to improve the durability of the self-ligating bracket and is collaboratively operated with a positioner to feature both advantages of operability and fixing power of the self-ligating bracket.

### TECHNICAL FIELD OF THE INVENTION

The present invention relates to a structure of a self-ligating bracket, and more particularly to a structure of a self-ligating bracket that has a simplified structure, improved durability, excellent operability, and high fixing strength.

### DESCRIPTION OF THE PRIOR ART

A self-ligating bracket is provided to alleviate drawbacks of a traditional denture brace. The self-ligating bracket uses a fixed arch wire so as to reduce tying with tying wires or elastic elements. The self-ligating bracket allows an arch wire to insert or remove when set in an open condition, and the self-ligating bracket fixes the arch wire in an arch wire slot when set in a closed condition.

However, such a known self-ligating bracket suffers the following drawbacks and shortcomings that require further improvements:

Firstly, the process of manufacturing and assembling is sophisticated, so that the manufacturing efficiency is low and the fabrication cost and the sales prices are high.

Secondly, the self-ligating bracket includes a slide lid that is movable between an open position and a closed position. Multiplicity of movement of the slide lid between the open position and the closed position often results in failure of the self-ligating bracket due to elastic fatigue of a rubber ring or spring.

Thirdly, due to be small in the overall size, the strength of the slide lid is crucial factor that affects the control of force applied by an operator. In case that the strength of the slide lid is insufficient, the slide lid cannot be effectively kept in the closed position, and consequently, the arch wire cannot be securely fixed; oppositely, if the slide lid is overly strong, then the user has to apply a strong force for operation, and this may cause strong discomfort of the orthodontic patient.

### SUMMARY OF THE INVENTION

The primary objective of the present invention is that elastic clamping arms are arranged inside a receiving channel to constrain a positioner formed on a bottom of a movable lid, so as to feature both operation easiness and structural strength for movement of the movable lid between an open position and a closed position of a base body, thereby helping improve service life and reduce fabrication cost with a simplified structure.

To achieve the above objective, the present invention comprises, in a main structure thereof, a base body, a receiving channel, an elastic body that comprises two elastic clamping arms, a connection part, and a receiving space, a movable lid, a positioner, a sliding opening, a retaining part, two avoiding spaces, and two guide slopes. The receiving channel is formed in the base body. The elastic body is arranged in the receiving channel Two ends of the connection part are respectively connected to the elastic clamping arms. The receiving space is formed between the elastic clamping arms. The movable lid is movably arranged on the base body. The positioner is arranged on a bottom of the movable lid and is movable in the receiving channel The sliding opening is formed in a wall of the receiving channel to allow the positioner to pass. The retaining part formed on an end of the positioner and is contactable and engageable with the elastic clamping arms to prevent the positioner from detaching from the receiving channel The two avoiding spaces are respectively formed between the elastic clamping arms and sidewalls of the receiving channel, in order to accommodate the elastic clamping arms and to establish communication between the receiving space and the sliding opening when the elastic clamping arms are pushed aside by the positioner. Further, the two guide slopes are respectively formed on two opposite sides of the positioner for respectively pushing the two elastic clamping arms into the two avoiding spaces.

When the present invention is used for orthodontics, the base body is similarly bonded to a surface of a tooth, and the movable lid 4 is operable for controlled movement of opening and closing. In a closed condition, the positioner is located inside the receiving space, and the elastic clamping arms constrain movement of the positioner so as to achieve the purpose of securely fixing the movable lid. When the movable lid is pulled to move outwards, the elastic clamping arms may retract into the avoiding spaces and thus setting the receiving space in communication with the sliding opening, so as to allow the positioner move out of the receiving channel, but is still affected by the retaining part being in contact engagement with the elastic clamping arms, so that the movable lid is prevented from separating and detaching from the base body, and only a minor force so applied may allow the movable lid to be opened, and easy operability is also ensured. Further, when the movable lid is re-closed, the guide slopes push the elastic clamping arms toward the avoiding spaces on the two sides. Thus, the present invention features all advantages of strengthened structure, simplified design, and easy operation.

Based on the above-described techniques, the drawbacks of the prior art self-ligating brackets in respect of complicated fabrication process, high cost, easy elastic fatigue, short service life, and hand control of strength of slide lid can be overcome, and advantages in practical use as noted above can be achieved.

### BRIEF DESCRIPTION OF THE DRAWINGS

FIG. 1 is a perspective view showing a preferred embodiment of the present invention.

FIG. 2 is an exploded view of the preferred embodiment of the present invention.

FIG. 3 is a plan view, in a see-through form, of the preferred embodiment of the present invention.

FIG. 4 is a schematic view illustrating a lid opening operation of the preferred embodiment of the present invention.

FIG. 5 is another schematic view illustrating the lid opening operation of the preferred embodiment of the present invention.

FIG. 6 is a schematic view illustrating a lid closing operation of the preferred embodiment of the present invention.

FIG. 7 is a plan view, in a see-through form, showing another preferred embodiment of the present invention.

FIG. 8 is an exploded view of said another preferred embodiment of the present invention.

### DETAILED DESCRIPTION OF THE PREFERRED EMBODIMENT

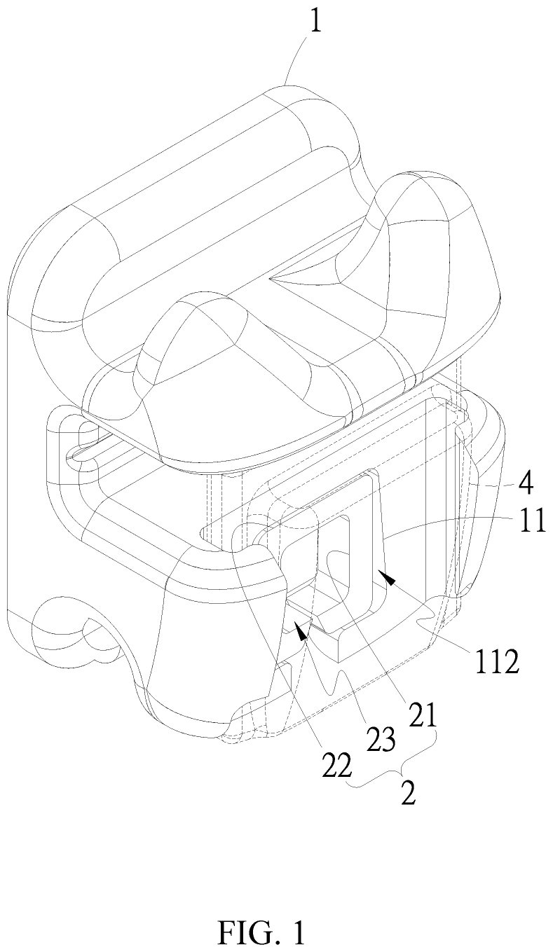

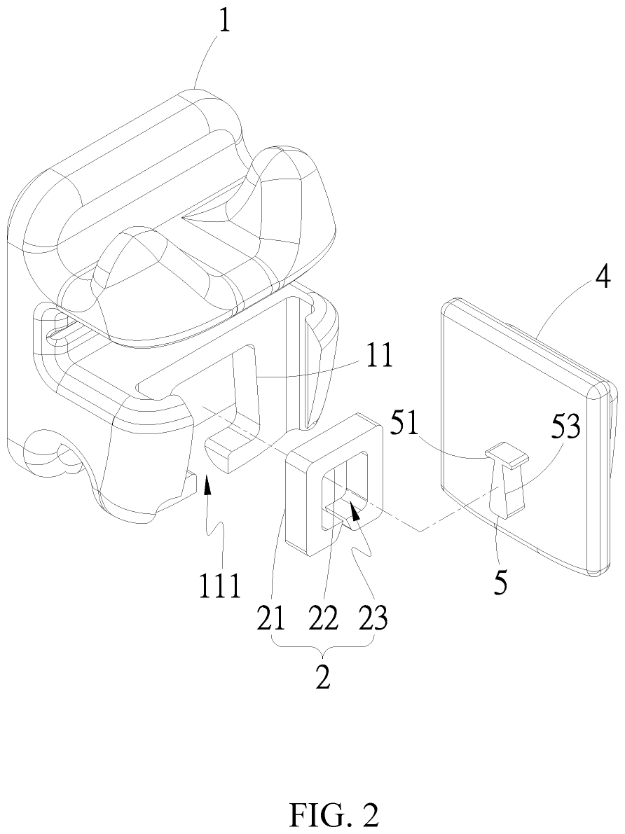

Referring to FIGS. 1 and 2, which are respectively a perspective view showing a preferred embodiment of the present invention and an exploded view of the preferred embodiment of the present invention, it can be clearly seen in the drawings that the present invention comprises:

a base body 1;

a receiving channel 11, which is formed in the base body 1;

an elastic body 2, which is arranged in the receiving channel 11, the elastic body 2 comprising two elastic clamping arms 21, a connection part 22 connecting between the two elastic clamping arms 21, and a receiving space 23 formed between the elastic clamping arms 21;

a movable lid 4, which is movably arranged on the base body 1;

a positioner 5, which is arranged on a bottom of the movable lid 4 and is movably receivable in the receiving channel 11;

a sliding opening 111, which is formed in a wall of the receiving channel 11 for the positioner 5 to pass;

a retaining part 51, which is formed at an end of the positioner 5 and is contactable and engageable with the elastic clamping arms 21 to prevent the positioner 5 from detaching from the receiving channel 11;

two avoiding spaces 112, which are respectively formed between the two elastic clamping arms 21 and sidewalls of the receiving channel 11 that are provided for accommodating the elastic clamping arms 21 when the elastic clamping arms 21 are pushed aside by the positioner 5 and are set in communication with the receiving space 23 and the sliding opening 111; and

two guide slopes 53, which are respectively formed on two opposite sides of the positioner 5 for pushing the two elastic clamping arms 21 aside to move into the two avoiding spaces 112 respectively.

The above description provides an understanding to the structure of the present invention, and based on a combination of such an arrangement, advantages of structure simplification, improved durability, excellent operability, and high fixing strength can be realized. Further details are provided below.

Referring collectively to FIGS. 1-6, which are respectively a perspective view showing a preferred embodiment of the present invention, an exploded view of the preferred embodiment of the present invention, a plan view, in a see-through form, of the preferred embodiment of the present invention, a schematic view illustrating a lid opening operation of the preferred embodiment of the present invention, another schematic view illustrating the lid opening operation of the preferred embodiment of the present invention, and a schematic view illustrating a lid closing operation of the preferred embodiment of the present invention, it can be clearly seen in the drawings that the base body 1 is formed with a wire trough 12 for receiving therein an arch wire. The receiving channel 11 is in the form of a trapezoidal notch formed in the base body 1 and having an opening that is in a direction facing upward as being the same as that of the wire trough 12. The sliding opening 111 is a sideway opening of the receiving channel 11 for allowing the receiving channel 11 to be in communication with the outside after combination with the movable lid 4. The movable lid 4 is inserted into the base body 1 in such a manner as to be movable only in a front-rear direction. The elastic body 2 is a metal or plastic member that is of an inverted U-shape and thus comprises a connection part 22 and two elastic clamping arms 21. The avoiding spaces 112 are gaps between the trapezoidal receiving channel 11 and the U-shaped elastic body 2. The positioner 5 and the movable lid 4 are integrally formed as a one-piece structure and the combination of the retaining part 51 and the positioner 5 are of a generally T-shaped configuration, and, in the entirety, a generally mushroom configuration is formed further through the combination of the guide slopes 53 with the positioner 5.

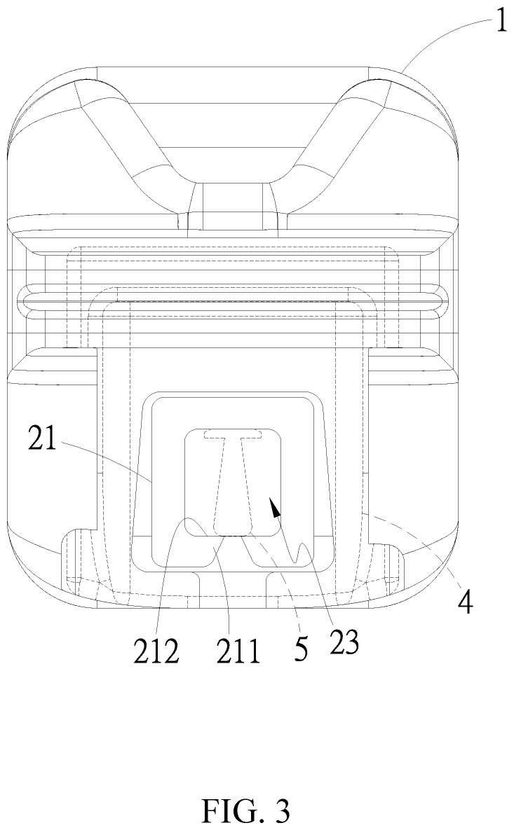

When the present invention is used for orthodontics, a bottom of the base body 1 is similarly bonded to a surface of a tooth, and the movable lid 4 is operable for controlled movement of opening and closing. In the closed condition, as shown in FIG. 3, the positioner 5 is located inside the receiving space 23, and the elastic clamping arms 21 constrain the positioner 5. In the embodiment, the elastic clamping arms 21 each have an end that comprises a hook part 211, and the hook part 211 has one side that is adjacent to the positioner 5 and is of a planar surface 212, such that a part of the positioner 5 that is in contact engagement with the hook part 211 is orthogonal to a direction of movement of the positioner 5 and consequently, the elastic clamping arms 21 may constrain the positioner 5 from movement and thereby achieving the purpose of securely fixing the movable lid 4.

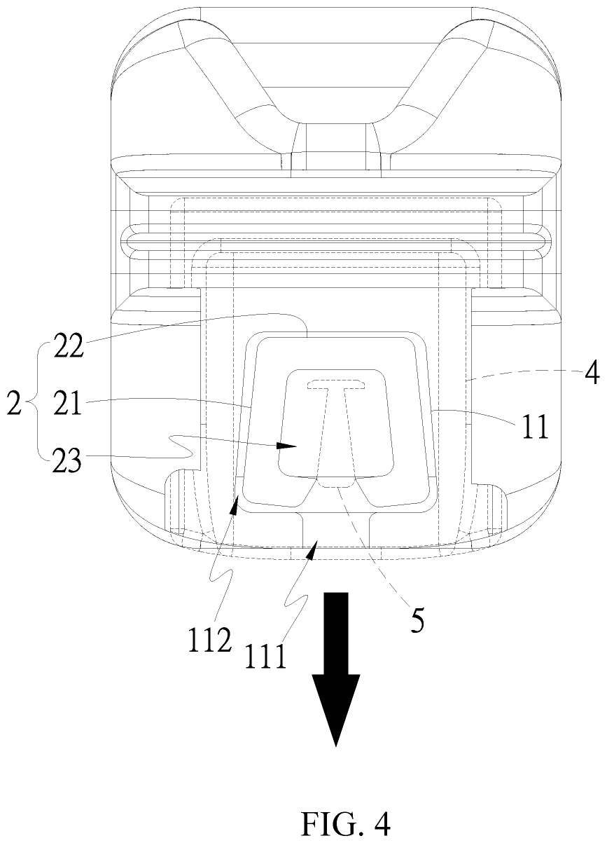

As shown in FIG. 4, when the movable lid 4 is pulled to move outwards, the connection part 22 is virtually in contact engagement with an upper side of the receiving channel 11 and is thus generally immobile; however, the elastic clamping arms 21 may retract into the avoiding spaces 112, so that the force that is applied to pull out the movable lid 4 may become a force acting on the elastic clamping arms 21 by means of the positioner 51, and the elastic body 2 only allows the elastic clamping arms 21 to retract sideways to the left and right sides, respectively, thereby making the receiving space 23 in communication with the sliding opening 111. Further, a distance by which the two elastic clamping arms 21 retract sideways is of a length that is generally the same as a width of the positioner 5 in order to allow the positioner 5 to pass therethrough for moving toward outside of the receiving channel 11, and consequently, the movable lid 4 is opened.

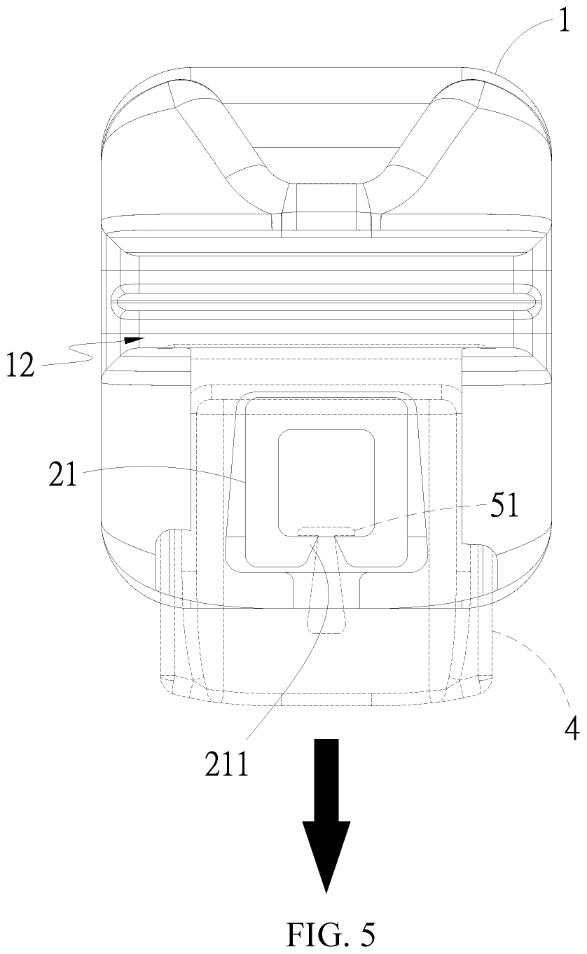

As shown in FIG. 5, when the movable lid 4 is moved to an open position, the wire trough 12 is exposed and under this condition, the movable lid 4 is still affected by the retaining part 51 being in contact engagement with the hook parts 211 of the elastic clamping arms 21, and thus, the movable lid 4 is not allowed to further move outwards so that the movable lid 4 does not completely separate and detach from the base body 1. Only a minor force so applied may allow the movable lid 4 to be opened, and easy operability is also ensured.

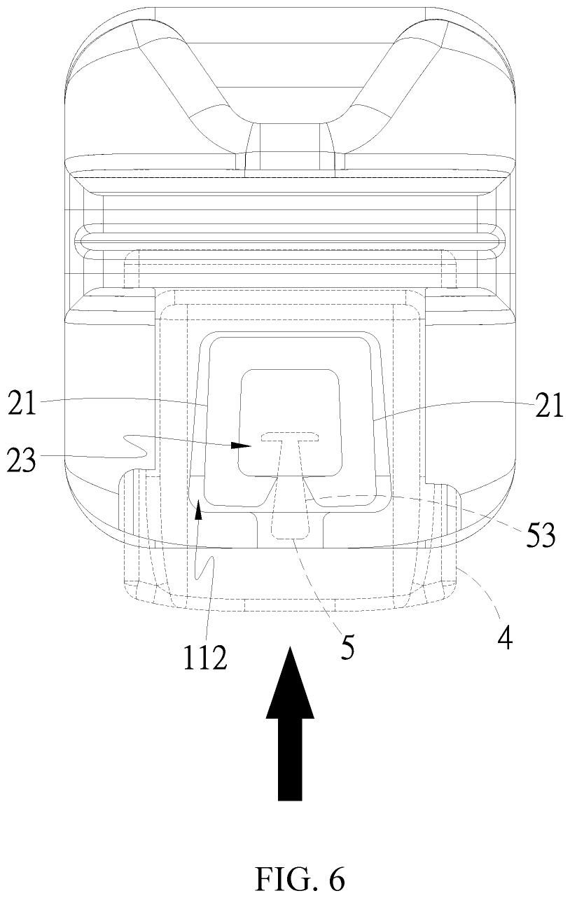

As shown in FIG. 6, when the movable lid 4 is re-closed, the guide slopes 53 respectively and gradually push the elastic clamping arms 21 toward the avoiding spaces 112 on the two sides to allow the positioner 5 to be completely received into the receiving space 23. During such an operation, the unique arrangement of the guide slopes 53 provide the positioner 5 with both advantages of structure strengthening and arrangement simplification. The guide slopes 53 are structured to make the elastic clamping arms 21 slowly deform toward the two sides and the slopes provide guidance that prevents sudden force impact on the elastic clamping arms 21 or undesired force concentration, so as to help reduce the risk of damage for the elastic clamping arms 21 or the positioner 5.

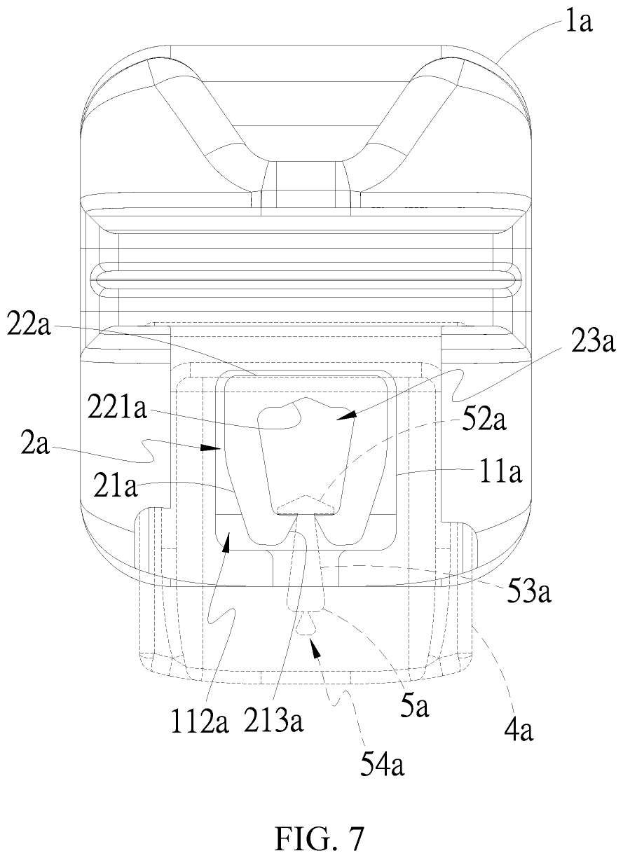

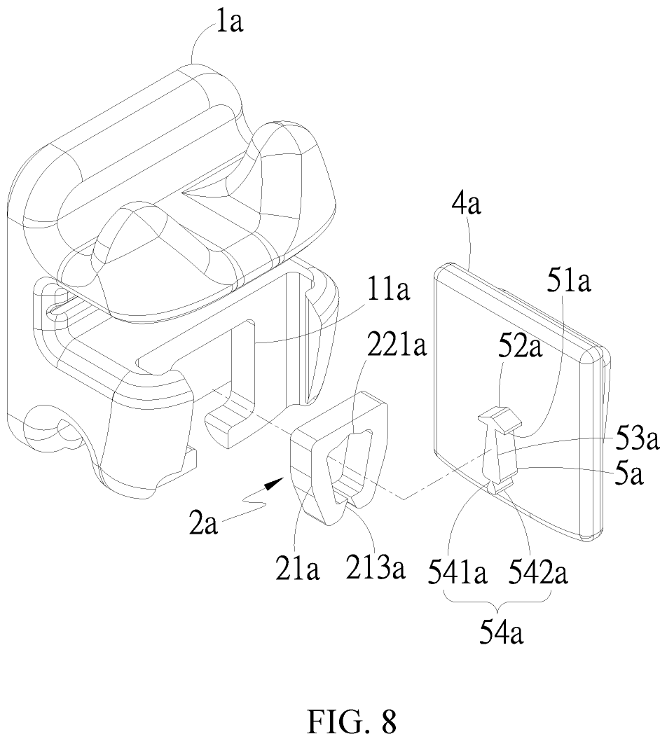

Referring to FIGS. 7 and 8, which are respectively a plan view, in a see-through form, showing another preferred embodiment of the present invention and an exploded view of said another preferred embodiment of the present invention, it can be clearly seen in the drawings that the instant embodiment is generally similar to the previous embodiment but with the receiving channel 11a being configured as a rectangular shape and terminal portions of the two elastic clamping arms 21a being contracted inward, wherein the elastic body 2a is made in a shape similar to a baseball home plate and portions of the two elastic clamping arms 21a that are respectively contactable with the guide slopes 53a are each provided with a sloping part 213a; and the retaining part 51a is formed, on one side thereof that is opposite to the positioner 5a, with a projecting part 52a, and a recessed part 221 is formed in the connection part 22a for receiving and holding the projecting part 52a. In the outside configuration, the combination of the projecting part 52a, the retaining part 51a and the positioner 5a looks like an arrow. Further, the positioner 5a is provided, at an end that is distant from the projecting part 52a, with an indicating part 54a. In this way, the configuration of the receiving channel 11a, in the entirety thereof, is of a rectangular shape and this would help reduce the difficulty of manufacturing the base body la and also reduces the fabrication cost thereof; and the shape of the elastic body 2a is modified accordingly, so that avoiding spaces 112a are still present between the receiving channel 11a and the elastic clamping arms 21a to ensure normal operation as discussed above.

In closing the movable lid 4a, in addition to the guide slopes 53a pushing open the elastic clamping arms 21a in directions toward the avoiding spaces 112a on the two sides, when the movable lid 4a is pushed to the end, the projecting part 52a is set into and in abutting engagement with the recessing part 221a, so as to have the positioner 5a completely located in the receiving space 23a. In such an operation, the unique arrangement of the projecting part 52a, the recessing part 221a, and the guide slopes 53a provides the positioner 5a, as being movable in such a minute operation space, with advantages of structure strengthening and arrangement simplification. Due to the overall size of the self-ligating bracket being relatively small (length and width being approximately 3 mm) and a major force acting portion of the retaining part 51a being of a width that is only around 0.1 mm in the force acting direction, the projecting part 52a is provided to increase the width of the retaining part 51a in order to improve force enduring strength thereof. The recessing part 221a is arranged to have a shape corresponding to the projecting part 52a in order to ensure the same stroke of movement for the positioner 5a, and further, the arrangement of the recessing part 221a help regulate the stress of the connection part 22a relative to the elastic clamping arms 21a so as to control the extent of swinging of the elastic clamping arms 21a and also the restoring spring force.

Further, the sloping parts 213a of the elastic clamping arms 21a are provided to operate collaboratively with the guide slopes 53a during the movement of the positioner 5a in a direction for closing, in order to reduce the frictional force induced between the elastic clamping arms 21a and the guide slopes 53a to thereby improve service life thereof. Further, the indicating part 54a provided at the end of the positioner 5a is a projecting structure showing a water droplet shape, and comprising a contracting part 541a at a front end and a diverging part 542a formed at one side of the contracting part 541a. The contracting part 541a has a width that is smaller than a width of the positioner 5a, so that when the movable lid 4a is moving toward the closing position, the elastic clamping arms 21a undergoes instantaneous shrinking or snapping at the site of the contracting part 541a, and the diverging part 542a helps to prevent excessive movement of the movable lid 4a. Vibration caused by such an operation may help improve hand feeling for an operator to server as a reminder that the movable lid 4a has reached a predetermined location.

1. A self-ligating bracket structure, comprising:
a base body;
a receiving channel, which is formed in the base body;
an elastic body, which is arranged in the receiving channel, the elastic body comprising two elastic clamping arms, a connection part connecting between the two elastic clamping arms, and a receiving space formed between the elastic clamping arms;
a movable lid, which is movably arranged on the base body;
a positioner, which is arranged on a bottom of the movable lid and is movable in the receiving channel;
a sliding opening, which is formed in a wall of the receiving channel to allow the positioner to pass;
a retaining part, which is formed on an end of the positioner and is contactable and engageable with the elastic clamping arms to prevent the positioner from detaching from the receiving channel;
two avoiding spaces, which are respectively formed between the two elastic clamping arms and sidewalls of the receiving channel to accommodate the elastic clamping arms and to establish communication between the receiving space and the sliding opening when the elastic clamping arms are pushed aside by the positioner; and
two guide slopes, which are respectively formed on two opposite sides of the positioner for respectively pushing the two elastic clamping arms into the two avoiding spaces.

2. The self-ligating bracket structure according to claim 1, wherein the two elastic clamping arms are each formed with a sloping part at a portion thereof that is contactable with the guide slopes.

3. The self-ligating bracket structure according to claim 1, wherein the retaining part is formed with a projecting part on one side thereof that is distant from the positioner, and the connection part is formed with a recessed part for accommodating and holding the projecting part.

4. The self-ligating bracket structure according to claim 3, wherein the positioner includes an indicating part at an end thereof that is distant from a projecting part.

5. The self-ligating bracket structure according to claim 4, wherein the indicating part comprises a contracting part arranged at a front end and a diverging part arranged at one side of the contracting part.

6. The self-ligating bracket structure according to claim 1, wherein the receiving channel is of a trapezoidal form and the elastic body is of an inverted U-shaped configuration.

7. The self-ligating bracket structure according to claim 1, wherein the receiving channel is of a rectangular form and the elastic body has an outline in which the two elastic clamping arms are contracted inward and incline toward each other.
